(19) United States
(12) Patent Application Publication
(10) Pub. No.: US 2025/0197627 A1
(43) Pub. Date: Jun. 19, 2025

(54) BLOCK COPOLYMER COMPOSITION AND ANION EXCHANGE MEMBRANES MADE THEREFROM

(71) Applicant: Notark Corporation, The Woodlands, TX (US)

(72) Inventors: Jiaqi YAN, Houston, TX (US); Roger TOCCHETTO, Houston, TX (US); Vijay MHETAR, Houston, TX (US)

(73) Assignee: Notark Corporation, The Woodlands, TX (US)

(21) Appl. No.: 18/979,716

(22) Filed: Dec. 13, 2024

Related U.S. Application Data
(60) Provisional application No. 63/609,404, filed on Dec. 13, 2023.

(51) Int. Cl. C08L 53/02; C08C 19/06; C08C 19/22; C08L 23/16; C08L 71/12

(52) U.S. Cl. CPC C08L 53/025; C08C 19/06; C08C 19/22; C08L 23/16; C08L 71/12; C08L 2203/16; C08L 2312/00

(57) ABSTRACT

The disclosure relates to a composition comprising a quaternized crosslinked epoxy functionalized partially hydrogenated styrenic block copolymer (QxE-pHSBC), and a thermoplastic polymer (TP). The TP is characterized as having a tensile strength of >30 MPa, flexural modulus of >1.8 GPa, and heat deflection temperature of ≥75° C. The styrenic block copolymer precursor for QxE-pHSBC can have any of a sequential diblock, triblock or coupled structure, which can be extended to a tetrablock, a pentablock or a monohydroxylated block copolymer, with at least one of the blocks functionalized (epoxidized) and crosslinked.

### RELATED APPLICATIONS

This application claims benefit to U.S. provisional application No. 63/609,404, filed on Dec. 13, 2023, which is hereby incorporated herein by reference.

### FIELD

The disclosure relates to a composition comprising a quaternized crosslinked epoxy functionalized styrenic block copolymer and a thermoplastic polymer, methods of preparation, and applications thereof.

### BACKGROUND

Anion exchange membrane (AEM) is a key component for many electrochemical devices, such as fuel cells and electrolyzers. However, the relatively low hydroxide conductivity, and insufficient long-term chemical and mechanical stabilities have been major barriers for wider adoptions of AEM-based technologies. To address those issues, various synthetic approaches have been explored with an aim to increase ion exchange capacity and to introduce crosslinker within the membrane. These approaches, however, typically require multiple synthetic steps to achieve the overall material design with tailorable functionality and improved mechanical properties.

The performance of the AEM depends on the type of materials used in the AEM. Hydrogenated styrene-butadiene block copolymers (SEBS) and unhydrogenated styrenic block copolymer (USBC) have a great application prospect in phase separation and good alkali resistance due to the unique characteristics of alternating soft and hard blocks and an all-carbon main chain. USBCs have sufficiently reactive sites in the form of unsaturation. Functionalized SBCs serve as a precursor material, which provides an excellent membrane processability. However, AEMs based on these polymers have challenges in terms of poor stability in basic environment, low ionic conductivity, and reduction in mechanical strength due to the water absorption.

There is still a need for a composition having improved stability, high ion conductivity and electrochemical performance, and balanced mechanical properties to fit AEM application requirements.

### SUMMARY

In one aspect, the disclosure relates to a composition comprising a thermoplastic polymer selected from the group consisting of polytetrafluoroethylenes (PTFEs), polyolefins, polyimides, polyamides, polyesters, polystyrenes, polysulfones, polyketones, poly(p-phenylene oxide) (PPO), polyphenylene ethers, polyisoprenes, polybutadienes, polyvinylidene fluorides, polycarbonates, polyetherimides, ethylene-vinyl alcohol copolymers, polyvinylidene chlorides, polyacrylates, polytertbutylstyrene, and mixtures thereof and a quaternized crosslinked epoxy functionalized partially hydrogenated styrenic block copolymer represented by at least one formula selected from: S-BD-E/B, S-BD-E/B-S, (S-BD-E/B)ₙX, S-I/EP-S, and (S-I/EP)ₙX, wherein n=2-7 and X is the residual of a coupling agent. Each block S is a polymer block composed of vinyl aromatic units, and each block S has a peak molecular weight of 5 to 50 kg/mol measured according to ASTM 5296-19. each block I is a quaternized crosslinked polymer block composed of isoprene units selectively epoxidized with an epoxy functional group, each block EP is a polymer block composed of an ethylene-propylene block each block BD-E/B is a quaternized crosslinked polymerized block, composed of butadiene units selectively epoxidized with an epoxy functional group, and ethylene/butylene unit, the block BD-E/B has a structure according to formula (I);

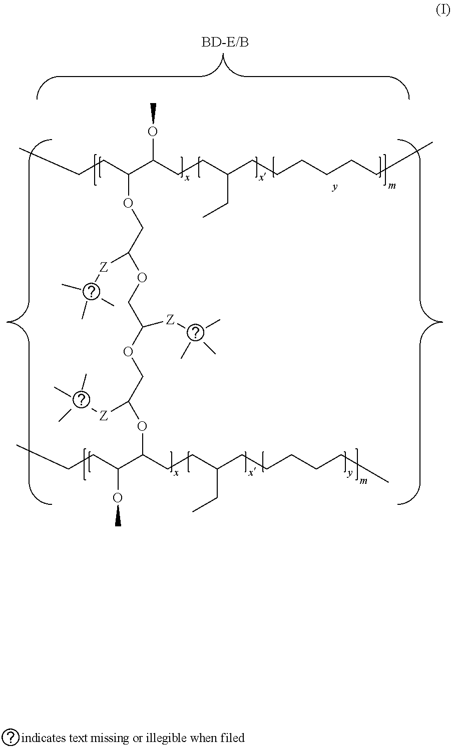

wherein R² is H or CH₃, x, x′, and y refer to number of blocks within block B and x+x′+y is greater than or equal to 2, provided x is at least 1 and y is at least 1. Z is any of a linear alkyl chain of C₁₋₁₂, a cyclic alkyl chain of C₃₋₁₂, or a branched alkyl chain of C₄₋₁₂; and HL⁻ is a counter ion selected from OH⁻, HCO₃⁻, CO₃²⁻, F⁻, Cl⁻, Br⁻, and I⁻. A film prepared from the composition after soaking in 1 molar KOH for 500 hours at 800° C. exhibits at least one of the following properties, measured according to ASTM D412, a Young's modulus of 40 to 300 MPa, an elongation at break of 10 to 40%, a tensile strength of 3 to 20 MPa, and a toughness of 1 to 5 MJ/m3.

In another aspect, a film prepared from the composition after soaking in 1 molar KOH for 500 hours at 80° C. exhibits any of: an increase in tensile strength of >25%, an increase in Young's Modulus of >50%, and an increase in toughness of >50% over a film made with the quaternized crosslinked epoxy functionalized partially hydrogenated styrenic block copolymer without any of the thermoplastic polymer.

In still another aspect, the film after soaking in 1M KOH solution at 80° C. for 500 hours, the film exhibits a reduction in OH ion conductivity of <45% compared to the OH-ion conductivity of the film before soaking, both measured in mS/cm at 80° C.

In yet another aspect, the thermoplastic polymer is a polyphenylene ether having a peak molecular weight of 6.5 to 50 kg/mol measured according to ASTM 5296-19.

In one aspect, the thermoplastic polymer is miscible with the vinyl aromatic units in the block S.

In another aspect, the film after soaking in 1M KOH solution at 80° C. for 500 hours, the film exhibits a reduction in OH⁻ ion conductivity of <45% compared to the OH— ion conductivity of the film before soaking, both measured in mS/cm at 80° C.

In still another aspect, the anion exchange membrane (AEM) comprising the composition containing quaternized crosslinked epoxy functionalized partially hydrogenated styrenic block copolymer and thermoplastic polymer.

### DESCRIPTION

The following terms will have the following meanings:

“Consisting essentially of” means that the claimed composition primarily contains the specified materials, with allowances for additional components that do not materially affect novel characteristics or function of the claimed invention, with the additional components, if present, in an amount of <30%, or <20%, or <10%.

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other combinations of A, B, and C.

“Any of A, B, or C” refers to one option from A, B, or C, e.g., A only, B only, or C only.

“Any of A, B, and C” refers to one or more options from A, B, and C, e.g., A only, B only, C only, A and B, A and C, A and B and C, etc.

“Block” as used herein refers to a section of a polymer molecule that comprises a plurality of identical constitutional units (monomers) and possesses at least one constitutional or configurative feature that does not appear in the immediately adjacent sections (blocks).

“Conjugated diene” refers to an organic compound containing conjugated carbon-carbon double bonds and a total of 4 to 12 carbon atoms, such as 4 to 8 carbon atoms, which can be any of 1,3-butadiene and substituted butadienes, including but not limited to 1,3 cyclohexadiene, isoprene, 2,3-dimethyl-1,3-butadiene, 1-phenyl-1,3-butadiene, 1,3-pentadiene, 3-butyl-1,3-octadiene, chioroprene, and piperylene, or any combination thereof. In embodiments, the conjugated diene block comprises a mixture of butadiene and isoprene monomers. In embodiments, 1,3-butadiene alone is used.

“Butadiene” refers to 1,3-butadiene.

“Monovinyl arene,” or “monoalkenyl arene,” or “vinyl aromatic” refers to an organic compound containing a single carbon-carbon double bond, at least one aromatic moiety, and a total of 8 to 18 carbon atoms, such as 8 to 12 carbon atoms. Examples include any of styrene, o-methyl styrene, p-methyl styrene, p-tertbutyl styrene, 2,4-dimethyl styrene, alpha-methyl styrene, vinylnaphthalene, vinyltoluene, vinylxylene, or mixtures thereof. In embodiments, the monoalkenyl arene block comprises a substantially pure monoalkenyl arene monomer. In some embodiments, styrene is the major component with minor proportions (less than 10 wt. %) of structurally related vinyl aromatic monomers such as o-methylstyrene, p-methyl styrene, p-tert-butyl styrene, 2,4-dimethyl styrene, a-methylstyrene, vinylnaphtalene, vinyltoluene, vinylxylene, or combinations thereof. In embodiments, styrene alone is used.

“Vinyl content” refers to the content of a conjugated diene that is polymerized via 1,2-addition in the case of butadiene, or via 3,4-addition in case of isoprene, resulting in a monosubstituted olefin, or vinyl group, adjacent to the polymer backbone. Vinyl content can be measured by nuclear magnetic resonance spectrometry (NMR).

“Coupling efficiency (CE)” refers to the weight of coupled polymer molecules divided by the total weight of both coupled and uncoupled polymer molecules, expressed as a percentage (%). CE can be used to determine the amount of diblock content in the overall block copolymer. For example, if the coupling efficiency is 80%, the polymer will contain 20 wt. % diblock and 80 wt. % triblock and/or multi-arm blocks.

“Polystyrene content” or PSC of a block copolymer refers to the % weight of vinyl aromatic, e.g., polystyrene in the block copolymer, calculated by dividing the sum of molecular weight of all vinyl aromatic blocks by the total molecular weight of the block copolymer. PSC can be determined by using any suitable methodology such as proton nuclear magnetic resonance (NMR).

“Molecular weight” or M_{w} refers to the polystyrene equivalent molecular weight in kg/mol of a polymer block or a block copolymer. M_{w} can be measured with gel permeation chromatography (GPC) using polystyrene calibration standards, such as is done according to ASTM 5296-19. The GPC detector can be an ultraviolet or refractive index detector or a combination thereof. The chromatograph is calibrated using commercially available polystyrene molecular weight standards. M_{w} of polymers measured using GPC are polystyrene equivalent molecular weights or apparent molecular weights, measured at the peak of the GPC trace, and commonly referred to as polystyrene equivalent “peak molecular weights,” designated as Mₚ. Individual GPC block M_{w} can be calculated by the difference of Mₚ measured before and after the considered block polymerization. For example, M_{w} of block B is the Mₚ of species A-B minus the Mₚ of block A.

“Hydrogenation level” (H2%) refers to the level of saturation of the olefinic double bonds into the block copolymer, which can be determined using UV-VIS spectrophotometry and/or ¹HNMR and/or via ozonolysis titration.

“Residual Unsaturation (RU)” refers to the levels of unsaturation, i.e., carbon-carbon double bonds per gram of block copolymer. RU can be measured using ¹HNMR or ozonolysis titration.

“Unit” as in the context of polymer unit or copolymer unit refers to repeating building blocks constituting the considered polymer or copolymer. Those polymer units are usually directly or indirectly related to the monomers that were polymerized or copolymerized to produce the polymer or copolymer.

“Crosslinking”, refers to the process of chemically joining two or more molecules by a covalent bond. It also refers to the process where monomers capable of reacting with the functional groups on the polymer chain in the presence of an appropriate catalyst, results in graft-from growth of branching chains, some of which react with other chains of structure. Crosslinking can be achieved by curing using thermal or radiation treatment (UV), or neutralization. Crosslinking reagents can contain reactive ends to specific functional groups (primary amines, acrylates, sulfides, etc.) on polymers or other molecules.

“Membrane” refers to a pliable sheet or layer of a material (film or coating etc.), which can function as a selective barrier allowing something, e.g., molecules, ions, gases, or particles, etc., to pass through but stops others.

“Anion exchange membrane” or “alkaline exchange membrane” or “AEM” refers to a semipermeable membrane generally made from ionomers and designed to conduct anions and repel cations.

“Anion exchange membrane electrolyzers” (AEME) or “Anion exchange membrane water electrolyzers” (AEMWEs) refers to an electrolyzer with an ion-conducting polymer electrolyte membrane separating the anode from the cathode. The electrolyzers use electricity to split water (H₂O) into hydrogen and oxygen through an electrochemical reaction.

“Ion Exchange Capacity” or IEC refers to the total active sites or functional groups responsible for ion exchange in a polymer. Generally, a conventional acid-base titration method is used to determine the IEC, see for example International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which is the weight of the polymer required to provide 1 mole of exchangeable protons.

“Ion conductivity” is a measure of a substance's (here membrane's) tendency towards ionic (e.g., Br⁻, OH⁻) conduction. Ionic conduction is the movement of ions and one mechanism of current. Ion conductivity is commonly measured by methods such as electrochemical impedance spectroscopy.

“p-HSBC” refers to a partially hydrogenated styrenic block copolymer. The partially hydrogenated styrenic block copolymer is based on blocks of conjugated diene and styrenic monomers in which fraction of the double bonds resulting from the conjugated diene units have been reduced or hydrogenated, with “partially” meaning the conjugated bond partially (e.g., >20%, or <70%, or <80%, or <97%) hydrogenated. The level of hydrogenation in hydrogenated vinyl aromatic polymers can be determined using UV-VIS spectrophotometry and/or proton NMR.

Partial or partially hydrogenated styrenic block copolymer is used interchangeably with pHSBC.

Epoxidized PHSBC (E-pHSBC), or epoxy-grafted p-HSBC, or epoxy-functionalized p-HSBC, are used interchangeably to refer to a composition where epoxy groups are grafted on the backbone or to the vinyl group adjacent to the polymer backbone of a partially hydrogenated styrenic block copolymer (pHSBC).

“Thermoplastic polymer” refers to a type of polymer material specifically designed to have superior mechanical, thermal, and chemical properties, making it suitable for use in demanding applications, often as an alternative to metals or ceramics. These polymers are typically characterized by their strength, durability, and resistance to wear, heat, and chemicals, for example, tensile strength of >30 MPa, flexural modulus of >1.8 GPa, and heat deflection temperature of >=75° C.

The disclosure relates to a composition comprising: a quaternized crosslinked epoxy functionalized partially hydrogenated styrenic block copolymer (QxE-pHSBC), and at least a thermoplastic polymer (TP). The QxE-pHSBC can have any of a sequential diblock, triblock or coupled structure, which can be extended to a tetrablock, a pentablock, with at least one of the blocks is crosslinked, quaternized and epoxy functionalized.

Quaternized crosslinked epoxy functionalized partially hydrogenated styrenic block copolymer (QxE-pHSBC): The QxE-pHSBC is obtained from a partially hydrogenated styrenic block copolymer (pHSBC) precursor. The pHSBC precursor is first epoxy functionalized forming an epoxidized partially hydrogenated styrenic block copolymer (E-pHSBC), followed by crosslinking and quaternization to form the QxE-pHSBC.

pHSBC precursor: The pHSBC containing ethylenic unsaturation can be obtained by copolymerizing one or more olefins, including at least one conjugated diene, by themselves or with one or more alkenyl aromatic hydrocarbon monomers. The copolymers may or may not be tapered, the individual blocks may be homopolymers or random copolymers, and the polymer molecule may be linear or branched.

In embodiments, the copolymers have a general configuration selected from: sequential diblock structures such as: A-B, A-B/B′, or A-B/A, sequential triblock structures, such as A-B-A, A-B-B′-A, or A-B/B′-A or coupled structures such as (A-B)ₙX, (A-B-B′)ₙ-X, (A-B/B′)ₙ-X, (A-B/A)ₙ-X, (A-B-A-B′)ₙX, (A-B-B′-A-B)ₙ-X, (A-B/B′-A-B)ₙ-X, or (A-B/A-A-B)ₙ-X and mixtures thereof, wherein n is a positive integer, X is residue of a coupling agent, and each I is predominantly a polymer block of polymerized isoprene monomer. Each block A is predominantly a polymer block of a monoalkenyl arene monomers. In embodiments, the polymer blocks B and B′ are the same or different and selected from conjugated diene monomers.

The designation of “n,” refers the number of “arms” or “branches” in each of the structure, with n>=1. In embodiments, n ranges from 1-20, or 1-10, or 1-7.

Block A is selected from the group comprising: styrene, vinyl aromatic, alpha-methyl styrene, methyl styrene, para-methyl styrene, ethyl styrene, propyl styrene, butyl styrene, tert-butyl styrene, dimethyl styrene, vinyl toluene, isomers of vinyl toluene, vinyl xylene, 1,1-vinyl biphenyl, vinyl naphthalene, vinyl anthracene, and mixtures thereof.

In embodiments, the polymer block A has a molecular weight (Mₚ) of 3-30, 5-50, or 10-100, or 15-150, or 20-225, or 25-250, or 30-300 kg/mol. In embodiments, the polymer block A constitutes ≤50, or 5-55, or 10-35, or 15-25, or 5-20, or 5-15, 5-20 wt. %, based on the total weight of the pHSBC.

Each of polymer block B and B′ comprises a polymer or copolymer (e.g., B/B′, or B/B, etc.) of a conjugated diene monomer selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, piperylene, cyclohexadiene, and mixtures thereof.

In embodiments, each of polymer block B and B′ has a molecular weight (Mₚ) of 2-350, or 5-300, or 7-250, or 10-200, or 5-150, or 3-100 kg/mol. In embodiments, the polymer block B constitutes from up to 100 wt. %, or 70-95, or 75-95, or 80-95, or 85-95, or 75-85, or 80-90, or >75 wt. %, based on total weight of the p-HSBC.

In embodiments, after partial hydrogenation, the copolymers have a general configuration selected from: S-BD-E/B, S-BD-E/B-S, (S-BD-E/B)ₙX, S-I/EP-S, and (S-I/EP)ₙX, with n=2-7 and X is the residual of a coupling agent. Each S block is a monoalkenyl arene block. BD-E/B is butadiene-ethylene/butylene block, I/EP is isoprene-ethylene-propylene block.

The block copolymer is partially selectively hydrogenated, meaning the hydrogenated conjugated diene has a hydrogenation level of 20-97%, or >20%, or 30-95%, or >40%, or <70%, or <80%, or <97%.

The block copolymer, which is selectively partially hydrogenated, contains residual aliphatic double bonds in the polymer. In embodiments, the partially hydrogenated conjugated diene has a residual unsaturation or RU of <20 meq/g, or <15 meq/g, or <10 meq/g, or <8 meq/g, or >3 meq/g, or <5 meq/g, or 2-15 meq/g, or >0.5 meq/g.

In embodiments, each polymer block(S) has a molecular weight of 5-20 kg/mol, or 9-12 kg/mol, or at least 9.0 kg/mol, or at least 8.5 kg/mol, or at least 5.0 kg/mol, for each of the polymer block(s).

In embodiments, the pHSBC has an average 1,2-vinyl content of 8-80%, or 15-75%, or 25-60 wt. % 35-50%, or >35%, or <75%, the vinyl content can be measured before hydrogenation, via 1HNMR.

In embodiments, total polystyrene content (PSC) prior to hydrogenation is >20%, or 25-40%, or >18%, or <45%.

In embodiments, the pHSBC has a M_{w} of 50-500 kg/mol, or 60-400 kg/mol, or 75-250 kg/mol, or <400 kg/mol or <300 kg/mol or <200 kg/mol.

Epoxidized pHSBC (E-pHSBC): The precursor pHSBC can be epoxidized with the incorporation of functional groups into the base polymer. In embodiments, pHSBC is epoxidized by generally known methods such as the use of a peracid exemplified by peracetic acid, hydrogen peroxide in the presence of acetic acid and sulfuric acid or hydrogen peroxide in the presence of a low molecular weight fatty acid such as formic acid. Relatively low temperatures are utilized in the order of 25-40° C., and reaction times of 0.5 to 4 hours are usually sufficient for effecting the high degree of epoxidation desired in the conjugated diene polymer block.

In embodiments, the peroxides used as functionalization/epoxidizing agent include percarboxylic acids such as performic acid, peracetic acid, perpropionic acid, 3-chloroperoxybenzoic acid, potassium peroxymonosulfate, and mixtures thereof.

The amount of the functionalization/epoxidizing agent added to the pHSBC varies based on the desired level of functionalization. In embodiments, the epoxidizing agent is added in an amount ranging from 0.1-20, or 0.5-15, or 1-12, or 2-10 wt. %, based on the total weight of the pHSBC.

In embodiments, E-pHSBC has a degree of epoxidation of up to 100, or 1-99, or 5-90, or 10-80, or 20-70, or 30-90, or 40-80, or >40, or >50%, relative to the polymer block susceptible to functionalization.

In embodiments, E-pHSBC is partially hydrogenated and contains up to 20% of unhydrogenated units which are not epoxidized.

Crosslinked Epoxidized pHSBC (xE-pHSBC): In embodiments, the E-pHSBC is crosslinked chemically, thermally or by UV irradiation in combination with a suitable photoinitiotors and optional additives to obtain a crosslinked E-pHSBC (xE-pHSBC).

In embodiments, the cross-linking agent is a halo-oxirane represented by the formula (a) having halo group at its molecular terminals:

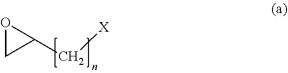

wherein n=1 to 8, X is halo group selected from Br⁻, Cl⁻, I⁻ F⁻

In embodiments, the crosslinking agent is selected from the group of halides of aliphatic or araliphatic hydrocarbons, bis(chloromethyl)benzene, or silicon tetrachloride, halide alkyl oxiranes such as halide (hexyl/butyl/octyl) oxiranes, acrylates, isocyanurates, aliphatic polyisocyanates, aromatic polyisocyanate, di-isocyanates, polyols such as aliphatic polyester diol, silanes such as alkoxy or vinyl silanes, siloxanes, polyether modified siloxanes, thiols, compounds having two or more vinyl, allyl or isopropenyl groups, anhydrides and mixtures thereof.

In embodiments, an amount of cross-linking agent is from 5-100, or 10-80, or 20-70, or 5-90, or 40-80, or 50-80, or 30-70 mol %, based on total mol of the epoxidized diene monomers in the polymer block B.

In embodiments, the photoinitiator is used to initiate crosslinking reaction by UV irradiation. The suitable photoinitiator, selected from but not limited to diaryliodonium, alkoxy-substituted diaryliodonium, triarylsulfonium, dialkylphenacyl sulfonium or dialkyl-4-hydrophenylsulfonium salts, which include, (4-octyloxyphenyl)-phenyl-iodonium hexafluoroantimonate, Triphenylsulfonium hexafluorophosphate, and triarylsulphonium hexafluorophosphate. Bis(dodecylphenyl) iodonium hexafluoroantimonate, 4-Thiophenyl phenyl diphenyl sulfonium hexafluoroantimonate, and mixturs thereof. In embodiments, the onium salts are used alone or in conjunction with a photosensitizer to respond to long wavelength UV and visible light. Examples of photosensitizers include thioxanthone, anthracene, perylene, phenothiazione, 1,2-benzathracene coronene, pyrene and tetracene.

In embodiments, the photoinitiator is present in an amount of 0.1-10 wt. %, or 0.2-8 wt. %, or 0.5-6 wt. %, or 1-4 wt. %, or <10 wt. %, or >0.1 wt. based on the epoxidized diene monomers in the polymer block B.

In embodiments, the crosslinking is initiated without the use of UV radiation by addition of a cationic initiator. Suitable initiators selected from the halides of tin, aluminum, zinc, boron, silicon, iron, titanium, magnesium and antimony, and the fluoroborates of these metals, BF complexes such as BF-ether and BF-amine, strong Bronsted acids such as trifluoromethanesulfonic (trific acid), salts of trific acid and mixtures thereof.

The crosslinking step further comprises optional additives, e.g., activators, curing agents, stabilizers, neutralizing agents, thickeners, coalescing agents, slip agents, release agents, antimicrobial agents, surfactants, antioxidants, antiozonants, color change pH indicators, plasticizers, tackifiers, film forming additives, dyes, pigments, UV stabilizers, UV absorbers, catalysts, fillers, other resins, redox couples, fibers, flame retardants, viscosity modifiers, wetting agents, deaerators, toughening agents, adhesion promoters, colorants, heat stabilizers, light stabilizers, lubricants, flow modifiers, drip retardants, antiblocking agents, antistatic agents, processing aids, stress-relief additives, etc., and mixtures thereof.

Examples of UV stabilizers include resorcinol's, salicylates, benzotriazoles, benzophenones, oxanilides, oxanilide-based compounds, hindered amine light stabilizers, piperidinol derivatives, triazines, and mixtures thereof.

In embodiments, the UV stabilizer is selected from but is not limited to 2-(2-hydroxyphenyl)-benzotriazole, 2,2,6,6-tetramethyl piperidine, bis(1,2,2,6,6-pentamethyl-4-piperidinyl)-3,5-bis(1,1-dimethylethyl-4-hydroxyphenyl)methyl-butyl propanedioate, 1-acetyl-4-(3-dodecyl-2,5-dioxo-1-pyrrolidinyl)-2,2,6,6-tetramethyl-piperidine, bis(2,2,6,6-tetramethyl-4-piperdinyl) decanedioate; 1-acetyl-4-(3-dodecyl-2,5-dioxo-1-pyrrolidinyl)-2,2,6,6-tetramethyl-piperidine, 2-hydroxybenzophenones, 2-(2-hydroxyphenyl)-1,3,5-triazines, benzenesulfonic acid, 3-(2H-benzotriazol-2-yl)-4-hydroxy-5-(1-methylpropyl)-, monosodium salt, tris(tetramethylhydroxypiperidinol) citrate, 2-(4,6-bis(2,4-dimethylphenyl)-1,3,5-triazin-2-yl)-5-octyloxyphenol, poly(4-hydroxyethyl-2,2,6,6-tetramethyl-1-piperidineethanol) succinate, bis(1,2,2,6,6-pentamethyl-4-piperidyl) sebacate, poly{[6-[(1,1,3,3-tetramethylbutyl)amino]]-1,3,5-triazine-2,4-[(2,2,6,6-tetramethyl-piperidyl)imino]-1,6-hexamethylene-bis[(2,2,6,6-tetramethyl-4-piperidyl)imino]}, polysuccinic acid, (4-hydroxy-2,2,6,6-tetramethyl-1-piperidineethanol) ester, poly[(6-morpholinyl-5-triazine-2,4-diyl) (2,2,6,6-tetramethylpiperidinyl) iminohexamethylene [(2,2,6,6-tetramethylpiperidyl)-imino]], 4-benzoyloxy-2,2,6,6-tetramethylpiperidine, tris(1,2,2,6,6-pentapiperidinyl) phosphite, and mixtures thereof. In embodiments, an amount of the UV stabilizer used in the composition is from 0.1-5, or 0.5-4.5, or 1-4, or 1.5-3.5, or 2-3 wt. %, based on the total weight of total weight of the E-pHSBC.

In embodiments, optional additives range from 0-30, or 1-25, or 3-20, or 5-15, or 8-14 wt. %, or >1 wt. %, or <15 wt. %, based on the total weight of the composition.

Forming QxE-pHSBC: In embodiments, xE-pHSBC reacts with a quaternary ammonium compound to substitute at least a portion of the halide functional groups with quaternary ammonium groups to obtain a quaternized xE-pHSBC (QxE-pHSBC). In some embodiments, a mixture of two quaternizing agents is used, such as, for example, dimethyl amine and trimethyl amine in a weight ratio of 50:50, or 40:60, or 30:70, 10 or 20:80, or 10:90, or 90:10, or 80:20, or 70:30, or 60:40.

In embodiments, an alkyltrialkylammonium is used as a quaternizing agent (QA). In embodiments, the QA is selected from the group of alkyltrialkylammonium such benzyltrimethylammonium (TMA), dimethylpiperazinium (DMP), benzyldicyclohexylmethylammonium (MCH), benzyldiisopropylmethylammonium (MiPr), trimethylhexylammonium (TMHA), benzyldimethylhexylammonium (DMHA), dimethyl amine or trimethyl amine (TMA) or triethyl amine or alkyl(C12-16)dimethylbenzylammonium chloride, benzethonium chloride, benzyl-C12-18-alkyldimethyl (benzyl (coconut oil alkyl) dimethylammonium chlorides, cetylpyridinium chloride, decyl isononyl dimethyl ammonium chloride, dioctyl dimethyl ammonium chloride, didecyl dimethyl ammonium chloride, laurylamine dipropylenediamine, N-octadecyldimethyl{3-(trimethoxysilyl) propyl}ammonium chloride, or tetradecyldimethyl(3-(trimethoxysilyl) propyl) ammonium chloride or pyrrolidinium or tetra-pyrrolidinium or benzyl phosphonium or piperidinium or bis ammonium or quinuclidine and mixtures thereof.

In embodiments, the quaternizing agent is used in an amount of >10 mol %, or 10-90, or 20-80, or 30-70, or 10-70, or 15-60, >20, or >40, or >60, or <90, or <80 mol %, based on the total weight of total weight of the xE-pHSBC.

In embodiments, the degree of quaternization in xE-pHSBC ranges from 30-95 mol %, or 15-80 mol %, or 20-70 mol %, or 25-60 mol %, or >20 mol %, or >50 mol %, based on the total number of monomer units.

In embodiments, the QxE-pHSBC is represented by any of S-I/EP-S and (S-I/EP)nX structure. Each block S is a polymer block composed of vinyl aromatic units. Each block I is a quaternized crosslinked polymer block composed of isoprene units selectively epoxidized with an epoxy functional group. Each block EP is a polymer block composed of an ethylene-propylene block.

In other embodiments, the QxE-pHSBC is represented by any of S-BD-E/B, S-BD-E/B-S, and (S-BD-E/B) nX structure. Each block S is a polymer block composed of vinyl aromatic units. Each block BD-E/B is a quaternized crosslinked polymerized block composed of butadiene units selectively epoxidized with an epoxy functional group and ethylene/butylene units. In embodiments, each block BD-E/B is represented by formula (I):

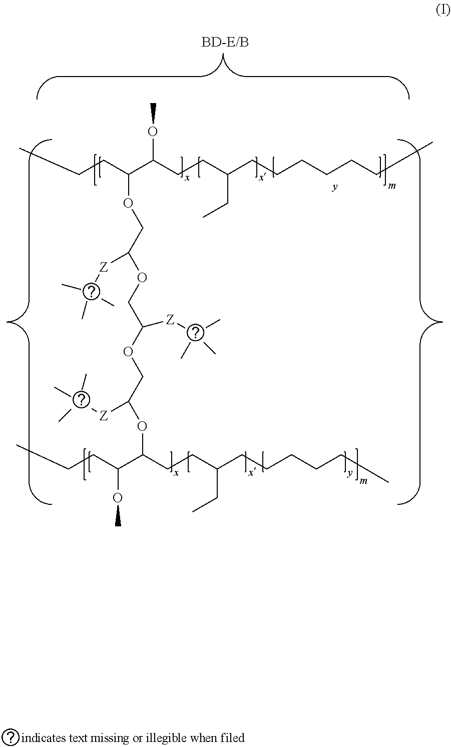

In the formula (I), R2=H, CH3; x+x′+y>=2, provided x is at least 1 and y is at least 1, and refers to the number of blocks, m>1; Z is any of a linear alkyl chain of C1-12, a cyclic alkyl chain of C3-12, or a branched alkyl chain of C4-12; and HL⁻ is a counter ion selected from OH⁻, HCO₃⁻, CO₃²⁻, F⁻, Cl⁻, Br⁻, and I⁻.

In embodiments where the cross-linking agent is haloalkyl-oxirane, the epoxide groups on E-pHSBC react with epoxides of haloalkyl-oxirane to graft the haloalkyl side chains onto the polymer (E-pHSBC). The graft chains from BD of one polymer connect with BD on a second polymer as shown in formula (I). Alternatively, the epoxide groups on E-pHSBC backbone react with each other to generate crosslinked polymer network. In embodiments, the epoxide groups on haloalkyl-oxirane react with each other to produce linear biproduct which is eliminated in washing (water) step.

Thermoplastic Polymer (TP): In embodiments, a TP is selected from the group consisting of polytetrafluoroethylenes (PTFEs), polyolefins, polyimides, polyamides, polyesters, polystyrenes, polysulfones, polyketones, poly (2,6 dimethyl 1,4 phenylene) ether, poly(p-phenylene oxide) (PPO), polyphenylene ethers, polyisoprenes, polybutadienes, polyvinylidene fluorides, polycarbonates, polyetherimides, ethylene-vinyl alcohol copolymers, polyvinylidene chlorides, polyacrylates, polytertbutylstyrene, styrene-acrylonitrile (SAN), acrylonitrile butadiene styrene (ABS), high-impact polystyrene (HIPS), and mixtures thereof.

In embodiments, the TP is characterized as having a tensile strength of >30 MPa, a flexural modulus of >1.8 GPa, and a heat deflection temperature of ≥75° C.

In embodiments, the TP is selected to be miscible with the vinyl aromatic block in the QxE-pHSBC, e.g., the polystyrene. Examples include polyphenylene ether (PPE), styrene-acrylonitrile (SAN), acrylonitrile butadiene styrene (ABS), high-impact polystyrene (HIPS), and mixtures thereof. In embodiments, the TP is polyphenylene ether.

In embodiments, the soluble TP (in an organic solvent) is non-reactive to the photoinitiator used to initiate crosslinking reaction by UV irradiation. Examples of organic solvents include n-hexane, cyclohexane, and polar solvents, e.g., methanol, ethanol, isopropyl alcohol, benzyl alcohol, 2-methoxy ethanol, methylene chloride, ethylene chlorides, acetone, N, N-dimethylacetamide, 1-methyl-2-pyrrolidinone, 1,3-dioxolane, dimethylformamide, and mixtures thereof.

In embodiments, the TP molecular weight is tailored (selected) to obtain miscibility between the QxE-pHSBC and the TP. In embodiments, the TP is a polyphenylene ether having a molecular weight ranging from 6.5 to 50 kg/mol, or 7 to 45 kg/mol, 10-35 kg/mol, or 15-30 kg/mol. In embodiments, a TP is selected for a M_{w} ratio of the TP to the M_{w} of the para-substituted vinyl aromatic block in the QxE-pHSBC ranging from 1:2 to 2:1, or 3:4 to 4:3, or 5:4 to 4:5, or 3:2 to 2:3, or 7:4 to 4:7.

In embodiments, the TP is present in an amount from 5-50%, or 10-30%, or 15-25% or >5%, or >15% relative to the weight of the vinyl aromatic blocks of QxE-pHSBC.

Method of Preparation of E-pHSBC: In embodiments, the E-pHSBC is obtained by a series of reaction steps including first preparing the SBC precursor. The SBC precursor can be prepared by methods known in the art and disclosed and taught in U.S. Pat. No. 7,449,518, incorporated herein by reference. Typically, the SBC precursor is prepared by an anionic polymerization using a sequential (or successive) polymerization of monomers in solution in the presence of an initiator followed by terminating of polymerized block copolymer chains. The polymerization of monomers can be performed by stepwise addition of the monomer to the solution containing the initiator, followed by coupling of the resulting sequential block copolymer chains with a coupling agent (if present), then followed by a hydrogenation step for making the partially hydrogenated SBC (pHSBC).

In embodiments, the production of epoxy functionalized pHSBC comprises: the first step of epoxidizing a p-HSBC in the presence of an epoxidizing agent and a solvent to accelerate epoxidation reaction to produce an epoxidized p-HSBC (E-pHSBC). Next, the E-pHSBC is neutralized/washed with water. After washing, water is removed by extraction, then solvent is removed by evaporation under vacuum to obtain E-pHSBC. In embodiments, the epoxidation reaction is carried out for a sufficient time and at a temperature of 10-70° C., or 15-55° C., or 40-50° C. The amount of the epoxidizing agent added to pHSBC varies based on the desired level of functionalization. Typically, this amount is in the range of 0.1-20, or 0.5-15, or 1-12, or 2-10 wt. %, based on the total weight of the pHSBC and the epoxidizing agent.

Preparation of xE-pHSBC: In embodiments, E-pHSBC is mixed with a halo-oxirane crosslinker and a photoinitiator in a solvent. The amount of crosslinker is in excess to the amount of E-pHSBC and is in a ratio of 0.5:1.5, or 1:2, or 1:3, or 10:25. The mixture is then cast onto a substrate to form a film or membrane. The mixture/sample is UV irradiated to simultaneously crosslink the E-pHSBC via one or more ether linkages and functionalize the E-pHSBC with a plurality of halide functional groups. In embodiments, the film has a degree of crosslinking ranging from 10-90, or 20-80, or 30-75, or 35-85, or 25-60, or up to 100%. In embodiment with a bromooxirane as the crosslinking agent, the alkylbromide chains are grafted onto the polymer to obtain xE-pHSBC via one or more ether linkages.

In embodiments, a membrane/film is formed by using casting, electrospinning, extrusion, compression, coating, such as dipping, flow coating, roll coating, bar coating, spray coating, curtain, rotogravure, brushing, wire wound rod coating, pan fed reverse roll coating, nip-fed coating, spraying, knife coating, spin coating, immersion coating, slot-die coating, ultrasonic spray coating, and the like. The film can be dried from room temperature to 80° C., or 30-70° C., or 35-65° C., with or without vacuum for a period of 1 hr.-7 days, or 5 hrs.-5 days, or 10 hrs.-2 days. In embodiments, the film is a standalone film or supported on the substrate, e.g., glass, plastic, ceramic, porcelain, and the like.

The solvent can be selected from n-hexane, cyclohexane, methylene chloride, ethylene chlorides, isopropyl alcohol, acetone, N,N-dimethylacetamide, 1-methyl-2-pyrrolidinone, 1,3-dioxolane, 2-methoxy ethanol, dimethylformamide, benzyl alcohol, and mixtures thereof.

Preparation of QxE-pHSBC: In the quaternization step of the process, the xEp-HSBC membrane is immersed in a quaternizing agent, e.g., trimethylamine in ethanol solution or as in a vapor form. In embodiments, quaternization is carried out at a temperature from ambient to 80° C., and for a sufficient amount of time, e.g., 2-24 hours. The resulting AEMs can be washed with solvents or solutions, e.g., methanol, and air dried to obtain the QxE-pHSBC.

In embodiments, an ion exchange reaction is performed to make the membrane hydroxide conductive. In embodiments, 1 M NaOH or 1 M KOH solution is used to make the membrane conductive, where the membrane is soaked into the solution for 1-800 hrs.

Properties of the QxE-pHSBC Composition: Depending on the end-use applications, a film (membrane) obtained from the QxE-pHSBC composition has a thickness of 0.5-500 μm, or 0.1-200 μm, or 10-100 μm, or 1-50 μm, or 20-150 μm, or 50-300 μm.

The film is elastic and has a low swell property. The film is highly dimensionally stable, has high ion transport characteristics, methanol resistance, barrier properties, hardness, thermal/oxidative stability, and anti-fouling properties.

In embodiments, the film has a water uptake capacity of 2-100, or 10-90, or 20-80, or 30-60, or 10-50, or 30-80 wt. %, based on total weight of the film. In embodiments, the film has an ion exchange capacity (IEC) of 1.0-3.5, or 1.2-3.0, or 1.5-3, or >1, or <2, or <3, or >0.5 meq/g.

In embodiments, a film comprising the QxE-pHSBC exhibits hydroxide conductivity of >20 mS/cm, or >30 mS/cm, or >45 mS/cm, or >60 mS/cm, or >80 mS/cm, or >100 mS/cm, or 20-250 mS/cm, or <250 mS/cm at a temperature range of 20-100° C., measured using electrochemical impedance spectroscopy (EIS; Solartron, 1260 impedance analyzer, 1287 electrochemical interface, Zplot software) over a frequency range of 1˜10⁶ Hz with an AC amplitude of 10 mV. After soaking in 1M KOH solution at 80° C.

In embodiments, the film after soaking in 1 molar KOH solution at 80° C. for 500 hrs., 170 hrs. and 0 hrs. has a Young's modulus of 70-400, or 45-300, or 50-250, 55-200 MPa.

In embodiments, the film after soaking in 1 molar KOH solution at 80° C. for 500 hrs. 170 hrs. and 0 hrs. has a tensile strength of 1-35, or 2-30, or 3-25, or 5-20, or 7-18 MPa.

In embodiments, the film after soaking in 1 molar KOH solution at 80° C. for 500 hrs. 170 hrs. and 0 hrs. has a toughness of 1-8, or 1.5-6, or 1-5 MJ/m3.

In embodiments, the film after soaking in 1 molar KOH solution at 80° C. for 500 hrs. 170 hrs. and 0 hrs. an elongation at break of 5-60%, or 8-50%, or 10-40%, 12-35%.

Properties of Modified QxE-pHSBC Composition: “Modified QxE-pHSBC” here refers to a composition with the addition of a thermoplastic polymer (ETP), e.g., PPE. In embodiments, a film made from the modified QxE-pHSBC composition after soaking in 1 molar KOH for 500 hours at 80° C. is characterized as having any of: a) an increase in tensile strength of >25%, or >50%, or >75% over a film made from unmodified QxE-pHSBC, i.e., QxE-pHSBC by itself without any ETP (same soaking conditions); b) an increase in Young's Modulus by >50%, or >75%, or >100%; and c) an increase in toughness of >50%, or at least 75%, or at least 100% over an unmodified QxE-pHSBC. The improved physical properties are obtained without significant impact on the IEC or the elongation at break properties.

In embodiments, a film with a thickness of 0.1 to 200 μm prepared from Modified QxE-pHSBC has one or more or all the following properties.

In embodiments, the film has an ion exchange capacity (IEC) of 1.0-3.5, or 1.2-3.0, or 1.5-3, or >1, or <2, or <3, or >0.5 meq/g.

In embodiments, the film has a Br⁻ ion conductivity of 30-95, or 35-90, or 45-80, or 50-75 mS/cm at a temperature range of 25° C. to 80° C.

In embodiments, the film has a water uptake capacity of 1-100, or 10-90, or 20-80, or 30-60, or 10-50, or 30-80 wt. %, based on total weight of the film.

In embodiments, the film after soaking in 1 molar KOH solution at 80° C. for 500 hrs. has a Young's modulus of 8-120, or 10-100, or 15-85, 20-75, or >8, or >10, or >15, <120 MPa.

In embodiments, the film after soaking in 1 molar KOH solution at 80° C. for 500 hrs. has a tensile strength of 1-35, or 2-30, or 3-25, or 5-20, or 7-18 MPa.

In embodiments, the film after soaking in 1 molar KOH solution at 80° C. for 500 hrs. 170 hrs. and 0 hrs. has a toughness of 1-8, or 1.5-6, or 1-5 MJ/m3.

In embodiments, the film after soaking in 1 molar KOH solution at 80° C. for 500 hrs. 170 hrs. and 0 hrs. an elongation at break of 5-60%, or 8-50%, or 10-40%, 12-35%.

Applications: The composition containing the quaternary ammonium (QA) functional group and thermoplastic polymer will find applications where the combination of good strength, water and proton transport characteristics, high ion conductivity, long term durability, excellent dimensional stability and good alkaline stability of material is desired.

The composition can be used in electrochemical applications, such as in water electrolyzers (electrolyte), fuel cells (separator phase), proton exchange membranes for fuel cells, in electrode assemblies, including those for fuel cells, water electrolyzers (electrolyte), acid batteries (electrolyte separator), supercapacitors (electrolyte), separation cell (electrolyte barrier) for metal recovery processes, sensors (particularly for sensing humidity), humidity control devices, energy storage solutions such as in vanadium or iron redox flow battery membrane, in lithium-ion batteries as solid polymer electrolyte, and the like.

### Examples: The Following Examples are Intended to be Non-Limiting

The following tests were used:

The synthesis of E-pHSBC was characterized by proton nuclear magnetic resonance spectroscopy (1H NMR; Varian 500 MHz spectrometer, 23° C.) with CD₂Cl₂ as the solvent.

The epoxide ring-opening reaction and subsequent quaternization reaction was characterized by FT-IR (Nicolet-iS-50 FTIR spectrometer with an attenuated total reflection (ATR) accessory). The film was directly put onto the ATR diamond and spectra were recorded at room temperature.

The epoxide ring opening reaction was further characterized by differential scanning calorimetry (DSC) using TA Instruments Q2000 from −75° C.-250° C.

Mechanical properties, including toughness, Young's modulus, tensile strength, and elongation at break measured according to ASTM D412.

Mechanical properties were analyzed with the DMA (Q800, TA Instruments) equipped with nitrogen-controlled humidity chamber. Rectangular samples (20×5×0.03 mm) were tested using a tension clamp.

The components used in the examples include:
Table 1 provides component details, the precursor for Example 1 is pHSBC, HSBC-1 is comparative polymer 1 (comp poly 1), and commercial membrane (Sustainion®) as comparative polymer 2 (comp poly 2), SBC AEM membrane (AEM via alkylation) as comparative polymer 3 (comp poly 3).

TABLE 1

| | | RU | Total MW | Vinyl | | |
|---|---|---|---|---|---|---|
| Polymer | Structure | (meq/g) | (kg/mol) | content % | PSC % | MFR g/10 min |
| Comp poly -1 | S-E/B-S | <0.1 | 90 | — | 49 | 30-46 |
| | | | | | | (190° C./2.16 Kg) |
| Comp poly-2 | S-E/B-S | — | 47-51 | — | — | — |
| pHSBC | S-B-E/B-S | 2.0 | 250 | 37 | 20 | 10 |
| (precursor) | | | | | | (230° C./2.16 Kg) |

Commercial Membrane—imidazolium functionalized styrene polymer, average molecular weight of 47-51 kg/mol.
PPE 1—Polyphenylene ethers have a molecular weight of 6300 g/mol, a heat deflection temperature of 165° C., tensile strength of 66 MPa, and Tg 165° C.
PPE 2—Polyphenylene ethers have a molecular weight of 47,600 g/mol, a heat deflection temperature of 155° C., tensile strength of 79 Mpa, and Tg 214° C.

Example 1-Epoxidation of pHSBC (E-pHSBC): The pHSBC with a residual unsaturation level of 2 meq./g was dissolved in cyclohexane at 40° C. The formic acid concentration was varied to control the level of epoxidation. A 1.0:0.5 molar solution of formic acid and hydrogen peroxide was reacted to form performic acid, which was then added to the pHSBC solution in cyclohexane and stirred for 1 hour. The reaction was conducted in a batch reactor at 60° C. for 3 to 4 hours. To prevent secondary reactions, all reactions were immediately neutralized with sodium bicarbonate. The reaction mixture was washed twice with 10% aqueous sodium bicarbonate, and the polymer was precipitated using isopropyl alcohol (IPA). The precipitate was washed and analyzed by 1HNMR to determine the epoxy content. The final product obtained was epoxidized E-pHSBC.

Example 2-Crosslinking of E-pHSBC (xE-pHSBC): 3 g of E-pHSBC (from Example 1) was mixed with haloalkyl-oxirane (9.75 g) and a photoinitiator (1 wt. % relative to the total weight of E-pHSBC and oxirane) in 50 ml of chloroform. The solution was stirred thoroughly to ensure complete solubility. The chloroform mixture was cast, and the solvent was evaporated to form a film. The resulting film was cured under UV irradiation for 0.5 to 5 minutes, producing an xE-pHSBC film sample.

Example 3-Quaternization of xE-pHSBC (QxE-pHSBC): The xE-pHSBC film sample was quaternized by immersing it in a 40% trimethylamine/water solution for 48 hours. The quaternized film (QxE-pHSBC) was tested for Br ion conductivity at 25-80° C., as presented in Table 2. The QxE-pHSBC film was further evaluated for OH ion conductivity by soaking it in 1 M KOH solution at 25-80° C. for 500 hours. The results of ion conductivity, along with the mechanical properties of the film soaked in KOH at 80° C. for 170-500 hours, are reported in Tables 2 and 3.

TABLE 2

| | | | | | OH⁻ ion conductivity (mS/cm), after soaking in | | | | | |
|---|---|---|---|---|---|---|---|---|---|---|
| | | Br⁻ ion conductivity | | | 1M KOH solution at 80° C. | | | | | |
| | | (mS/cm) | | | at 25° C. | | at 60° C. | | at 80° C. | |
| Samples | IEC | 25° C. | 60° C. | 80° C. | 0 hr. | 500 hrs. | 0 hr. | 500 hrs. | 0 hr. | 500 hrs. |
| Sample-1 | 1.9 | 15.9 | 39.3 | 52.9 | 25.6 | 15.8 | 45.0 | 34.0 | 55.2 | 49.3 |
| QxE-pHSBC | | | | | | | | | | |

TABLE 3

| | soaking in | | | Young's | Elongation | Tensile | |
|---|---|---|---|---|---|---|---|
| | KOH at | | | modulus | at break | strength | Toughness |
| Examples | 80° C. | | IEC | (MPa) | (%) | (MPa) | (MJ/m³) |
| Sample-1 | 0 | hrs | 1.9 | 120.0 | 32.4 | 8.4 | 2.0 |
| (QxE-pHSBC) | | | | | | | |
| Sample-2 | 170 | hrs | | 73.4 | 27.8 | 4.5 | 0.9 |
| Sample-3 | 500 | hrs | | 85.4 | 29.1 | 5.0 | 1.1 |

Example 4-PPE Modified QxE-pHSBC (PPO-QxE-pHSBC-1): Film samples were prepared, one from QxE-pHSBC (no PPE), and one from PPE-modified QxE-pHSBC. The PPE-modified QxE-pHSBC film was prepared by dissolving PPE (Mw=6300 g/mol) and QxE-pHSBC at 50/50 wt. % (wt. % of PPE relative to the polystyrene component of QxE-pHSBC) in chloroform. First, a solution of PPE (0.2 g in 5 g chloroform) and QxE-pHSBC (3 g in 55 g chloroform) were prepared and mixed. Next, 9.75 g of a haloalkyl-oxirane crosslinker and 1 wt. % of photoinitiator (based on the total weight of polymer, PPE, and oxirane) were added to the premixed chloroform solution of PPE/QxE-pHSBC. The solution was stirred thoroughly to ensure complete solubility. The chloroform mixture was cast, and the solvent was evaporated to form a PPE/QxE-pHSBC film. The film was cured under UV irradiation for 0.5 to 5 minutes, producing a PPO-modified or reinforced QxE-pHSBC film. The resulting film was quaternized by immersing in a 31% trimethylamine/ethanol solution for 48 hours. The final PPE-QxE-pHSBC-1 membrane was tested for ion conductivity, aging, and mechanical strength. The swelling behavior of the film samples was measured in deionized (DI) water.

Results for the ion conductivity and swelling tests are presented in Table 4.

Example 5—PPE Modified QxE-pHSBC (PPE-QxE-pHSBC-2): The experimental procedure and test methods described in Example 1 were repeated, with the modification that 0.2 g of PPE (M_{w}=47,600 g/mol) was dissolved in 5 g of chloroform.

The results are presented in Table 4 along with comparative HSBC, SBC membranes (comp poly 1, 3) and a commercial membrane from SustainION (comp poly 2).

TABLE 4

| | | Ion conductivity (mS/cm) | |
|---|---|---|---|
| Description | IEC | 80° C. Br⁻ | 80° C. OH⁻ |
| Comp Poly 1 - SEBS | 1.44 | 28 | 36.8 |
| Comp Poly 2 - SustainION | 1.1 | — | 22.6 |
| Comp Poly 3 - AEM akylated SBC | 1.55 | 19.7 | 30.3 |
| PPE-QxE-pHSBC-1 | 1.82 | 37.1 | 52.4 |
| PPE-QxE-pHSBC-2 | 1.87 | 61.1 | 120.8 |

The mechanical properties of PPE modified QxE-pHSBC with and without PPE are reported in Table 6. The sample with 20% PPE shows the improved mechanical properties.

TABLE 6

| | PPE | | | | | | Water |
|---|---|---|---|---|---|---|---|
| | ratio | | Mechanical strength | | | | uptake in |
| | (PPE/ | | Young's | Elongation | Tensile | | DI water |
| | PS wt. | | Modulus, | at break | strength | Toughness, | 24 hr at |
| Sample | %) | IEC | (MPa) | (%) | (MPa) | (MJ/m³) | 80° C. |
| QxE-pHSBC -2 | 0.0 | 2.23 | 56.9 | 17.8 | 5.8 | 0.6 | 49% |
| PPE-QxE-pHSBC -2 | 0.2 | 2.03 | 113.8 | 18.0 | 9.2 | 1.1 | 33% |

As used herein, the term “comprising” means including elements or steps that are identified following that term, but any such elements or steps are not exhaustive, and an embodiment can include other elements or steps. As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the terms “include” or “contain” and their grammatical variants are intended to be non-limiting, such that recitation of items in a list is not to the exclusion of other like items that can be substituted or added to the listed items.

Unless otherwise specified, the recitation of a genus of elements, materials, or other components, from which an individual component or mixture of components can be selected, is intended to include all possible sub-generic combinations of the listed components and mixtures thereof.

The patentable scope is defined by the claims and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A composition comprising:
5-50 wt. % of a thermoplastic polymer having a tensile strength of >30 MPa, flexural modulus of >1.8 GPa, and heat deflection temperature of ≥75° C.; and
50-95 wt. % of a quaternized crosslinked epoxy functionalized partially hydrogenated styrenic block copolymer having a formula selected from: S-BD-E/B, S-BD-E/B-S, (S-BD-E/B)ₙX, S-I/EP-S, and (S-I/EP)ₙX,
wherein
$$n = 2 - 7 ;$$
X is the residual of a coupling agent;
each block S is a polymer block composed of vinyl aromatic units, and each block S has a peak molecular weight of 5 to 50 kg/mol measured according to ASTM 5296-19;
each block I is a quaternized crosslinked polymer block composed of isoprene units selectively epoxidized with an epoxy functional group, each block EP is a polymer block composed of an ethylene-propylene block;
each block BD-E/B is a quaternized crosslinked polymerized block, composed of butadiene units selectively epoxidized with an epoxy functional group, and ethylene/butylene unit, the block BD-E/B has a structure according to formula (I), 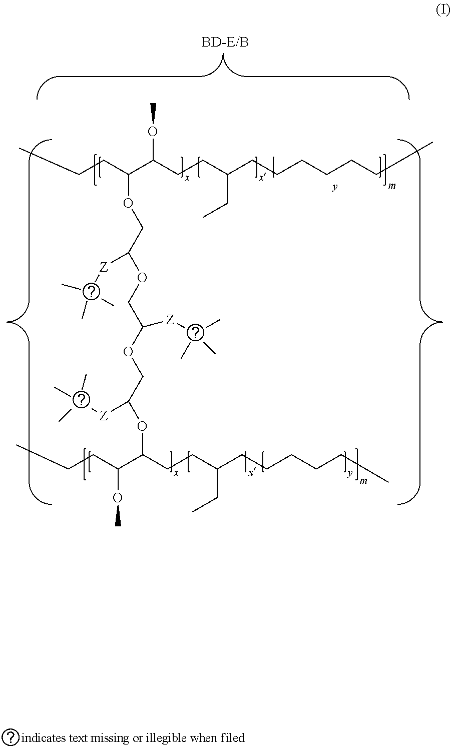
wherein,
R²=H, CH₃;
x+x′+y>=2, provided x is at least 1 and y is at least 1; m>1;
Z is any of a linear alkyl chain of C₁₋₁₂, a cyclic alkyl chain of C₃₋₁₂, or a branched alkyl chain of C₄₋₁₂; and
HL⁻ is a counter ion selected from OH⁻, HCO₃⁻, CO₃²⁻, F⁻, Cl⁻, Br⁻, and I⁻; and
wherein a film prepared from the composition after soaking in 1 molar KOH for 500 hours at 80° C. exhibits at least one of the following properties, measured according to ASTM D412;
a Young's modulus of 40 to 300 MPa;
an elongation at break of 10 to 40%;
a tensile strength of 3 to 20 MPa; and
a toughness of 1 to 5 MJ/m3.

2. The composition of claim 1, wherein a film prepared from the composition after soaking in 1 molar KOH for 500 hours at 80° C. exhibits any of: an increase in tensile strength of >25%, an increase in Young's Modulus of >50%, and an increase in toughness of >50% over a film made with the quaternized crosslinked epoxy functionalized partially hydrogenated styrenic block copolymer without any of the thermoplastic polymer.

3. The composition of claim 1, wherein prior to crosslinking and quaternization,
each block BD is partially hydrogenated to have a residual unsaturation of less than 10 meq/g; and
the block BD is selectively epoxidized at aliphatic double bonds for an amount of 0.1 to 7.0 meq of epoxy functional groups per gram of a partially hydrogenated styrenic block copolymer.

4. The composition of claim 1, wherein the thermoplastic polymer is selected from the group consisting of: polyphenylene ethers, polytetrafluoroethylenes, polyolefins, polyimides, polyamides, polyesters, polystyrenes, polysulfones, polyketones, polyisoprenes, polybutadienes, polyvinylidene fluorides, polycarbonates, polyetherimides, ethylene-vinyl alcohol copolymers, polyvinylidene chlorides, polyacrylates, polytertbutylstyrene, styrene-acrylonitrile (SAN), acrylonitrile butadiene styrene (ABS), high-impact polystyrene (HIPS), and mixtures thereof.

5. The composition of claim 1, wherein the thermoplastic polymer is miscible with the vinyl aromatic units in the block S.

6. The composition of claim 5, the thermoplastic polymer is selected from the group consisting of: polyphenylene ether, styrene-acrylonitrile, acrylonitrile butadiene styrene, high-impact polystyrene, and mixtures thereof.

7. The composition of claim 6, wherein the thermoplastic polymer is a polyphenylene ether having a peak molecular weight of 6.3 to 50 kg/mol measured according to ASTM 5296-19.

8. The composition of claim 1, wherein the thermoplastic polymer after dissolved in an organic solvent, is non-reactive to a photoinitiator;
wherein:
the organic solvent is selected from the group consisting of: n-hexane, cyclohexane, methanol, ethanol, isopropyl alcohol, benzyl alcohol, 2-methoxy ethanol, methylene chloride, ethylene chlorides, acetone, N, N-dimethylacetamide, 1-methyl-2-pyrrolidinone, 1,3-dioxolane, dimethylformamide, and mixtures thereof; and
the photoinitiator is selected from the group consisting of: diaryliodonium, alkoxy-substituted diaryliodonium, triarylsulfonium, dialkylphenacyl sulfonium or dialkyl-4-hydrophenylsulfonium salts, (4-octyloxyphenyl)-phenyl-iodonium hexafluoroantimonate, triphenylsulfonium hexafluorophosphate, triarylsulphonium hexafluorophosphate, bis(dodecylphenyl)iodonium hexafluoroantimonate, 4-thiophenyl phenyl diphenyl sulfonium hexafluoroantimonate, and mixtures thereof.

9. The composition of claim 1, wherein the quaternized crosslinked epoxy functionalized partially hydrogenated styrenic block copolymer is crosslinked using at least one cross-linking agent, followed by quaternization in the presence of at least one quaternizing agent.

10. The composition of claim 9, wherein the cross-linking agent is selected from the group consisting of: halides of aliphatic and aromatic hydrocarbons, halide alkyl oxiranes, bis(chloromethyl)benzene, silicon tetrachloride, halide alkyl, acrylates, isocyanurates, aliphatic polyisocyanates, aromatic polyisocyanate, di-isocyanates, polyols, silanes, siloxanes, polyether modified siloxanes, thiols, compounds having two or more vinyl, allyl or isopropenyl groups, anhydrides and mixtures thereof.

11. The composition of claim 9, wherein the quaternizing agent is selected from the group consisting of: dimethyl amine, trimethyl amine, 1-methyl piperidine, 1-methylimidazole, 1,2-dimethylimidazole, 2,4-dimethylimidazole, N-methylmorpholine, 3-hydroxypropyldimethylamine, n-butyldimethylamine, di(3-hydroxypropyl)methylamine, 2,3-dihydroxypropyldimethylamine, 3-hydroxypropyldiethylamine, 2-hydroxypropyldimethylamine, 4-hydroxybutyldimethylamine, 2-hydroxyethyldimethylamine, n-propyldimethylamine, 2-hydroxyethoxyethyldimethylamine, di(2-hydroxyethyl)methylamine, benzyldimethylamine and 4-hydroxybenzyldimethylamine, 3-ethylpyridine, 4-propylpyridine, 4-tertbutylpyridine, 4-cyanopyridine, 4-isopropylpyridine, 4-methoxypyridine, 3,4-lutidine, 3-methoxypyridine, 4-pyridinemethanol, N,N,N,N-tetramethyl hexyl diamine, and mixtures thereof.

12. The composition of claim 1, wherein:
the quaternized crosslinked epoxy functionalized partially hydrogenated styrenic block copolymer has the formula S-BD-E/B-S; and
the thermoplastic polymer is a polyphenylene ether.

13. A film comprising the composition of claim 1, wherein the counter ion (HL⁻) is OH⁻ and the film produced has a thickness of 0.1 to 200 μm.

14. The film of claim 13, wherein the film has an ion exchange capacity (IEC) ranging from 1 to 3.5 meq/g.

15. The film of claim 13, wherein the film has a water uptake capacity of 1-100% after immersion in deionized water at 80° C. for 24 hours, based on total initial weight of the film.

16. A film comprising the composition of claim 1, wherein the counter ion (HL⁻) is Br⁻ and the film produced has a thickness of 0.1 to 200 μm.

17. The film of claim 16, wherein the film has a Br⁻ ion conductivity of 15-75 mS/cm at a temperature range of 25° C. to 80° C.

18. A film comprising:
0.1-50 wt. % of a thermoplastic polymer having a tensile strength of >30 MPa, flexural modulus of >1.8 GPa, and heat deflection temperature of ≥75° C.; and
50-99.9 wt. % of a quaternized crosslinked epoxy functionalized partially hydrogenated styrenic block copolymer having a formula selected from: S-BD-E/B, S-BD-E/B-S, (S-BD-E/B)ₙX, S-I/EP-S, and (S-I/EP)ₙX,
wherein
$$n = 2 - 7 ;$$
X is the residual of a coupling agent;
each block S is a polymer block composed of vinyl aromatic units, and each block S has a peak molecular weight of 5 to 50 kg/mol measured according to ASTM 5296-19;
each block I is a quaternized crosslinked polymer block composed of isoprene units selectively epoxidized with an epoxy functional group, each block EP is a polymer block composed of an ethylene-propylene block;
each block BD-E/B is a quaternized crosslinked polymerized block, composed of butadiene units selectively epoxidized with an epoxy functional group, and ethylene/butylene unit, the block BD-E/B has a structure according to formula (I), 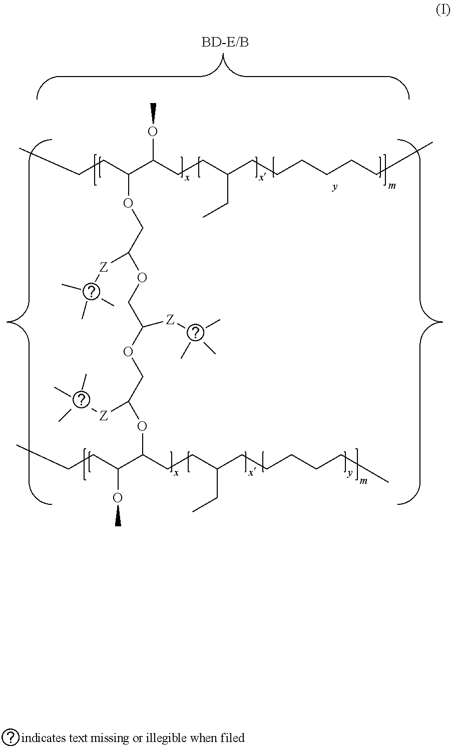
wherein,
R²=H, CH₃;
x+x′+y>=2, provided x is at least 1 and y is at least 1; m>1;
Z is any of a linear alkyl chain of C₁₋₁₂, a cyclic alkyl chain of C₃₋₁₂, or a branched alkyl chain of C₄₋₁₂; and
HL⁻ is a counter ion selected from OH⁻, HCO₃⁻, CO₃²⁻, F⁻, Cl⁻, Br⁻, and I⁻; and
optionally, up to 20 wt. % of an initiator, a curing agent, a stabilizer, a neutralizing agent, a surfactant, an antioxidant, a plasticizer, UV stabilizer, and mixtures thereof; and
wherein the film has a thickness of 0.1 to 200 μm, and the film exhibit at least one of the following properties, measured according to ASTM D412;
a Young's modulus of 40 to 300 MPa;
an elongation at break of 10 to 40%;
a tensile strength of 3 to 20 MPa; and
a toughness of 1 to 5 MJ/m3.

19. The film of claim 18, wherein the quaternized crosslinked epoxy functionalized partially hydrogenated styrenic block copolymer has the formula S-BD-E/B-S, and the thermoplastic polymer is a polyphenylene ether.

20. An anion exchange membrane (AEM) comprising the film of claim 18.
